(19) United States
(12) Patent Application Publication
(10) Pub. No.: US 2018/0349935 A1
(43) Pub. Date: Dec. 6, 2018

(54) METHOD AND SYSTEM FOR PRODUCT SALES PROMOTION USING SALES PROFIT DISTRIBUTION

(71) Applicant: SV INC., Seoul (KR)

(72) Inventors: Yong Hyun KANG, Suwon-si (KR); Du Hyun Kim, Seoul (KR)

(21) Appl. No.: 16/053,945

(22) Filed: Aug. 3, 2018

Related U.S. Application Data
(63) Continuation-in-part of application No. PCT/KR2017/000769, filed on Jan. 23, 2017.

(30) Foreign Application Priority Data
Feb. 6, 2016 (KR) 10-2016-0015339
Aug. 1, 2016 (KR) 10-2016-0098239

(51) Int. Cl. G06Q 30/02

(52) U.S. Cl. CPC G06Q 30/0213; G06Q 30/0215

(57) ABSTRACT

The disclosed technology may include: a member account unit allocated to a member who joins in a product sales promotion system; an order calculation unit for determining distribution order defined on the basis of the amount of cyber money accumulated in the member account unit; and a dividend distribution unit for distributing a priority member dividend, which is a first part of a dividend calculated from a paid product price, to at least some of priority members to a purchaser.

### CROSS-REFERENCE TO RELATED APPLICATION

The present application is a continuation-in-part of PCT Application No. PCT/KR2017/000769, filed on Jan. 23, 2017, which claims priority of Korean Patent Application No. 10-2016-0015339 filed on Feb. 6, 2016 and Korean Patent Application No. 10-2016-0098239 filed on Aug. 1, 2016. The contents of these applications and the contents of Korean Patent Application No. 10-2016-0072814 filed on Jun. 11, 2016, Korean Patent Application No. 10-2016-0073451 filed on Jun. 13, 2016, Korean Patent Application No. 10-2016-0080489 filed on Jun. 27, 2016 and Korean Patent Application No. 10-2016-0084447 filed on Jul. 4, 2016 are incorporated herein by reference in their entirety.

### BACKGROUND

### (a) Technical Field

An aspect of the disclosed technology relates to an E-commerce system and method using a financial technology. Particularly, an aspect of the disclosed technology relates to a product sales promotion system and method using sales profit distribution.

### (b) Description of the Related Art

E-commerce is the activity of buying or selling of products on online services or over the Internet. Recently, the E-commerce becomes to prevail the conventional off-line commerce, and therefore the technology advancing the E-commerce becomes more and more important.

A consumption behavior in a conventional economic system is carried out by paying for a product in cash and thus obtaining the product. Under such a structure, if large consumption is made, the cash assets of a consumer are just reduced, so that the consumer has to cut down his or her consumption so as to increase or maintain his or her cash assets.

If an economic depression occurs, accordingly, the consumer lowers his or her consumption, and thus, product sales are reduced. Subsequently, product sellers reduce the number of workers or their wage due to the decrement of their sales, and therefore, the consumer's income becomes reduced, so that he or she reduces the consumption more and more, thereby making such a vicious circle to be repeated under such a structure.

If the cash assets of the consumer are increased in related to his or her consumption, the phenomena will be reversed. In detail, the consumer increases his or her consumption more, and accordingly, product sales are drastically increased. Also, the product sellers increase the number of workers or their wage through the drastic increment of their sales and, in turns, the consumer's increased income promotes his or her consumption, so that if such an economic system is achieved, the world economy will be in the boom years.

Therefore, it will be a significant advance in the E-commerce if a new promoting technology providing a financial system wherein the cash assets of the consumer are increased in accordance with his or her consumption.

### SUMMARY

Various embodiments are provided to introduce a unique manner of a product sales promotion system and method that distributes a portion of a sales profit to other members having larger cyber money than purchasers as well as the purchasers to increase the assets of the purchasers themselves through their consumption and the consumption of other members.

The aspect of the product sales promotion system and method disclosed herein is not limited to the content as mentioned above, and other aspects not mentioned herein could be understood by the ordinary person in the art from the description below.

A product sales promotion system according to an embodiment of the disclosed technology may be a product sales promotion system for selling products on online and may include: a member account unit assigned to a member who joins in the product sales promotion system; an order calculation unit adapted to determine a distribution order in the order of the amount deposited in the member account unit; and a dividend distribution unit adapted to distribute a priority member dividend which is a part of the dividend calculated from a payment for a product to at least one priority member who ranks ahead a purchaser in the distribution order.

A product sales promotion system according to another embodiment of the disclosed technology may be a product sales promotion system for selling products on online and may include: a member account unit assigned to a member who joins in the product sales promotion system; an order calculation unit adapted to determine distribution order in the order of an amount deposited in the member account units; and a dividend distribution unit adapted to distribute a priority member dividend which is a part of a dividend calculated from a payment of a product to a priority member who ranks ahead a purchaser in the distribution order and the purchaser.

The dividend distribution unit may distribute a purchaser dividend which is another part of the dividend to the purchaser.

The sum of the priority member dividend and the purchaser dividend may be the same as the dividend.

After the dividend distribution unit distributes the purchaser dividend to the purchaser, the order calculation unit may determine the distribution order.

A product sales promotion method according to another embodiment of the disclosed technology may be a product sales promotion method for selling products through a product sales promotion system and may include: determining first distribution order in an order of the amount deposited in a member account unit assigned to a member who joins in the product sales promotion system by an order calculation unit; performing a payment for a product by a product payment unit; and distributing a priority member dividend which is a part of a dividend calculated from the payment for the product to at least one priority member who ranks ahead a purchaser in the distribution order by a dividend distribution unit.

In the distributing the priority member dividend, the priority member dividend may be distributed to every priority members who ranks ahead the purchaser in the distribution order and further distributed to the purchaser by the dividend distribution unit.

The product sales promotion method may further include the step of distributing a purchaser dividend which is another part of the dividend to the purchaser by the dividend distribution unit.

The sum of the priority member dividend and the purchaser dividend may be the same as the dividend.

After the dividend distribution unit distributes the purchaser dividend to the purchaser, the order calculation unit may update the distribution order, and the priority member dividend may be distributed according to the updated distribution order.

According to the embodiments of the disclosed technology, the product sales are promoted by distributing a portion of sales profit to other members having larger cyber money than the purchasers as well as the purchasers to increase the assets of the purchasers themselves through their consumption and the consumption of other members.

According to the embodiments of the disclosed technology, not only a part of the product price paid by a purchaser himself but also a part of the product price paid by the other purchaser is distributed to the purchaser. Therefore, the purchaser may expect a significant amount of profit through consumption. This promotes product sales.

According to the embodiments of the disclosed technology, a purchaser is given a portion of the distribution generated by subordinate purchasers and therefore, cyber money deposited in the member account of the purchaser a distribution ranking of the purchaser are increased. In turns, the purchaser is given more cyber money due to the increase of the distribution ranking. This mechanism promotes product sales.

As discussed above, the disclosed technology provides a significant improvement in promoting product sales.

### BRIEF DESCRIPTION OF THE DRAWINGS

FIG. 1 is a schematic block diagram showing a configuration of a product sales promotion system according to an embodiment of the disclosed technology.

FIG. 2 is a flowchart showing processes of selling products and distributing a dividend in the product sales promotion system according to a first embodiment of the disclosed technology.

FIG. 3 is a flowchart showing processes of selling products and distributing a dividend in the product sales promotion system according to a second embodiment of the disclosed technology.

FIG. 4 is a flowchart showing processes of selling products and distributing a dividend in the product sales promotion system according to a third embodiment of the disclosed technology.

FIG. 5 is a flowchart showing processes of selling products and distributing a dividend in the product sales promotion system according to a fourth embodiment of the disclosed technology.

FIG. 6 is an exemplary table showing first distribution order according to the amounts of cyber money of 10 purchasers who purchase clothing through the product sales promotion system according to the embodiment of FIG. 1.

FIG. 7 is an exemplary table showing purchase amounts of 10 purchasers who purchase clothing for three days through the product sales promotion system according to the embodiment of FIG. 1.

FIG. 8 is an exemplary table showing the dividends for the purchasers for a first order calculation period of time.

FIG. 9 is an exemplary table showing the dividends for the purchasers for a second order calculation period of time.

FIG. 10 is an exemplary table showing the dividends for the purchasers for a third order calculation period of time.

FIG. 11 is an exemplary table showing cyber money profit rates to the purchase amounts of the purchasers during an event.

### DETAILED DESCRIPTION

Hereinafter, a product sales promotion system and method according to an embodiment will now be described in detail with reference to the attached drawings. The embodiment is only an example of the invention. The features included in the embodiment are not necessarily essential to a solution of the invention. In describing the embodiment, an explanation of a well-known technology in the related art will be omitted for the brevity of the description.

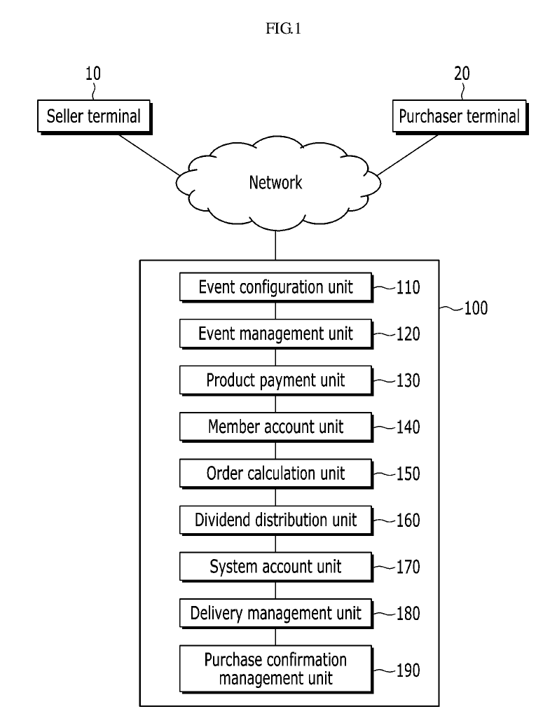

FIG. 1 is a schematic block diagram showing a configuration of a product sales promotion system according to an embodiment of the disclosed technology.

A product sales promotion system 100 according to an embodiment of the disclosed technology may include an event configuration unit 110, an event management unit 120, a product payment unit 130, a member account unit 140, an order calculation unit 150, a dividend distribution unit 160, a system account unit 170, a delivery management unit 180, and a purchase confirmation management unit 190.

The product sales promotion system 100 may be implemented with a microprocessor or a central processing unit (CPU), a storage device such as a volatile memory and/or a non-volatile memory, a communication device such as a modem, a network card, a Wi-Fi device, an infrared device, or a Bluetooth device, and peripheral devices. The respective units 110, 120, 130, 140, 150, 160, 170, 180, and 190 of the product sales promotion system 100 may be implemented by one or more software installed in the storage device and operated by the microprocessor or a central processing unit (CPU). The respective units 110, 120, 130, 140, 150, 160, 170, 180, and 190 of the product sales promotion system 100 may be implemented by one or more hardware respectively having a microprocessor or a central processing unit (CPU) and a storage device in which a software is installed. The product sales promotion system 100 may be implemented in one computer or a server, or may be implemented by a plurality of computers or servers distributed and linked to a communication network to provide communication between the distributed computers or servers.

The network provides data communication between the product sales promotion system 100 and the seller terminal 10 and the purchaser terminal 20. The network may be embodied in various types such as Internet, Local Area Network (LAN), Metropolitan Area Network (MAN), Wide Area Network (WAN) and etc.

A seller may be connected to the product sales promotion system 100 by using a seller terminal 10 through wired and wireless network. A purchaser may be connected to the product sales promotion system 100 by using a purchaser terminal 20 through the wired and/or wireless network. The seller terminal 10 and the purchaser terminal 20 may be devices for transmitting and receiving data to and from the product sales promotion system 100 connected thereto, and for example, desktop computers, laptops, smart phones, tablet computers, and so on may be used as the seller terminal 10 and the purchaser terminal 20. However, the seller terminal 10 and the purchaser terminal 20 are not limited to those mentioned above.

The seller and the purchaser may be members who join in the product sales promotion system 100, and the members of the product sales promotion system 100 may have a member account unit 140 connected to their own accounts. The member account unit 140 may include a cyber money account and/or a cash account. The cyber money deposited in the cyber money accounts may be used as a distribution standard when a dividend of a priority member, which will be discussed later, is distributed, and the dividend of the purchaser and the dividend of the priority member are put into the cyber money accounts in the form of cyber money. The cash in the cash accounts may be transferred to the cyber money accounts, exchanged with the cyber money in the rate of 1:1 or in a predetermined ratio, and deposited into the cyber money accounts. Contrarily, the cyber money in the cyber money accounts may be transferred to the cash accounts, but in this case, desirably, a withdrawal fee at a given percentage for the transferring money has to be paid. The withdrawal fee may be transferred to the system account unit 170 of the product sales promotion system 100, and the cash may be transferred to the cash accounts of the members. The cyber money may be referred to as different names, for example, reward points, mileages, coupons, credits, gifts, incentives, energy currency, etc.

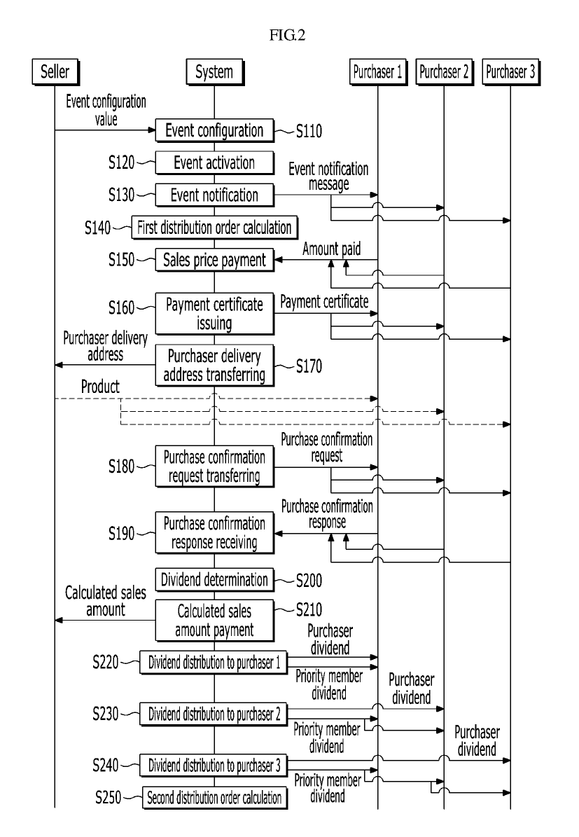

FIG. 2 is a flowchart showing processes of selling products and distributing a dividend in the product sales promotion system according to the first embodiment of the disclosed technology.

The seller is connected to the product sales promotion system 100 by using the seller terminal 10, and he or she selects an event configuration menu so as to set an event through which the dividend corresponding to a portion of the paid sales price is distributed to the purchaser and other members. The event configuration unit 110 displays, on the seller terminal 10, an input screen where, as event configuration values, a product category, a product name, the number of products to be sold, a period of time for product sales, a usage period of a product, a sales price of a product, a dividend distribution rate, a purchaser distribution rate, a priority member distribution rate, and an order calculation period of time, and so on are inputted, and the seller inputs, on the seller terminal 10, the event configuration values as required through the seller terminal 10. The values inputted to the event configuration unit 110 through the seller terminal 10 are stored in the event configuration unit 110, thereby completing setting the event (at step S110).

The event configuration values may be arbitrarily determined by the seller, and some of them may be suggested with appropriate values by means of the product sales promotion system 100. Further, some of them are, in advance, calculated as optimized values by means of the product sales promotion system 100 and provided as fixed values.

The event may be finished if the products to be sold are completely sold or the period of time for product sales ends, and it is possible that the number of products to be sold and the period of time for product sales are not set. The usage period of a product means a period of time during which a product (for example, coupon) can be effectively used. The sales price of the product may be a normal retail price of the product or a price discounted by a discount rate arbitrarily determined by the seller. The dividend distribution rate, the purchaser distribution rate, the priority member distribution rate, and the order calculation period will be explained later.

The event management unit 120 activates the event set on the event configuration unit 110 by the seller through the seller terminal 10 (at step S120).

If the event is activated, the event management unit 120 transmits an event notification message to the terminals of the members joined in the product sales promotion system 100 (at step S130). The members may register the products in which they are interested on member information, and the event management unit 120 may transmit the event notification message only to the members who have registered the products under the event as their interested products.

The order calculation unit 150 calculates first distribution order on the basis of the time when the event is activated (at step S140). The first distribution order is the member order determined according to the amounts of cyber money deposited in the cyber money accounts of the members joined in the product sales promotion system 100. In this case, the members may change cash into cyber money and deposit the cyber money into the cyber money accounts, thereby increasing the amounts of cyber money in the cyber money accounts.

For the conveniences of the description, only purchasers 1, 2 and 3 are illustrated in FIG. 2, and the exemplary case wherein their first distribution order is determined in the order of the purchasers 1, 2 and 3 will be explained below. Further, the step S140 is carried out before step S150 of making a payment for the sales price, but there is no restriction in the processing sequence only if the step S140 is carried out before the dividend distribution (Steps S220 to S240) to the purchasers.

So as to purchase the product, the purchaser makes a payment for the sales price of the product on the payment screen provided on the purchaser terminal 20 by the product payment unit 130 (at step S150), and the paid amount for the sales price is deposited into the system account unit 170. The payment may be made by the cash and/or cyber money withdrawn from the cyber money account and/or cash account of the purchaser, the card sales amount received from a credit card company of the purchaser, and the payment amount received from a smart phone communication company of the purchaser. The payment may be made by any known online payment method, and a detailed explanation on the payment method will be omitted.

If the payment for the product is made, the event management unit 120 issues a payment certificate and transfers the payment certificate to the purchaser terminal 20 (at step S160). The payment certificate may have a form of an electronic image.

The delivery management unit 180 may transmit a delivery address and a payment certificate of the purchaser who makes a payment for the sales price of the product to the seller terminal 10 to allow the seller to deliver the product to the purchaser (at step S170). A delivery method may include a delivery service and a direct delivery to the purchaser, and if the product is delivered directly to the purchaser, the seller scans bar codes on the payment certificate provided by the purchaser. After the purchaser is identified, accordingly, the product is taken over to the purchaser.

The purchase confirmation management unit 190 may transmit a purchase confirmation request to the purchaser who receives the product through the delivery service or directly receives the product from the seller (at step S180).

The purchase confirmation management unit 190 may receive the response to the purchase confirmation request from the purchaser (at step S190). The response to the purchase confirmation request is either a purchase confirmation response or a purchase cancel response. The purchase cancel response is the purchaser's expression to get a refund in case where the product purchased is unsatisfied. In this case, the event management unit 120 pays the paid amount as a refund to the purchaser who transmits the purchase cancel response. The refund is withdrawn from the amount kept in the system account unit 170 and is thus transferred to the cash account of the purchaser who transmits the purchase cancel response. Hereinafter, an explanation on the case where the response to the purchase confirmation request is the purchase confirmation response will be given.

If the order calculation period of time ends after the event is activated, the dividend distribution unit 160 multiplies the sum of the paid amounts of the purchaser who performs the purchase confirmation response within the order calculation period of time by the dividend distribution rate to determine the dividend generated by the purchaser (at step S200). A first part of the dividend is distributed to the members who ranks ahead the purchaser (hereinafter, referred to as “priority members”) in the first distribution order and the purchaser according to a predetermined priority member distribution method, and a second part of the dividend is distributed to the purchaser himself or herself. Desirably, the sum of the first part and the second part of the dividend is the same as the dividend of total. The dividend is transferred to the cyber money accounts of the purchasers and the priority members in the form of cyber money. According to the first embodiment of the disclosed technology, the dividend (the second part of the dividend) distributed to the purchaser is called “purchaser dividend”, the dividend (the first part of the dividend) distributed to each of the priority members and the purchaser according to the priority member distribution method, which is the amount calculated by subtracting the purchaser dividend from the dividend, is called “priority member dividend”, and the priority member dividend distributed to individual of the priority members is called “individual priority member dividend”. The individual priority member dividends are transferred to the cyber money accounts of the purchaser and the priority members in the form of cyber money.

The recipients of the priority member dividends may be selected among the all members joined in the product sales promotion system 100 or only among the purchasers who purchase the products sold through the event. That is, the distribution order may be calculated with respect to the all members or only the purchasers who purchase the products sold through the event.

The order calculation period of time may be set with a given period of time or in real time, and the given period of time may be set with a period of 12 hours, one day, or one week. If the order calculation period of time ends, the distribution order is updated. If the order calculation period of time is set in real time, the distribution order is updated right after the payments and purchase confirmation of the purchasers are finished.

The event management unit 120 may pay the amount of product sales calculated by subtracting the dividends from the total amount of product sales (which is calculated by multiplying the sales price by the number of purchase confirmed products) to the cash account of the seller (at step S210).

The dividend distribution unit 160 may multiply the dividend calculated by multiplying the sum of amounts paid by the purchaser 1 within the order calculation period of time by the dividend distribution rate by the purchaser distribution rate to calculate the purchaser dividend, and transfer the purchaser dividend to the cyber money account of the purchaser 1 (at step S220). The dividend distribution unit 160 may be scheduled to distribute the priority member dividend which is the remaining amount after subtracting the purchaser dividend from the dividend generated by the purchaser 1 to the priority members who rank ahead the purchaser 1 and the purchaser 1 according to the priority member distribution method. However, because there is no priority members who rank ahead the purchaser 1, the priority member dividend is distributed only to the purchaser 1 as the top priority member (at step S220).

The dividend distribution unit 160 may multiply the dividend calculated by multiplying the sum of amounts paid by the purchaser 2 within the order calculation period of time by the dividend distribution rate by the purchaser distribution rate to calculate the purchaser dividend, and transfer the purchaser dividend to the cyber money account of the purchaser 2 (at step S230). The dividend distribution unit 160 may distribute the priority member dividend which is the remaining amount after subtracting the purchaser dividend from the dividend generated by the purchaser 2 to the priority member (that is, the purchaser 1) who ranks ahead the purchaser 2 and the purchaser 2 according to the priority member distribution method (at step S230).

The dividend distribution unit 160 may multiply the dividend calculated by multiplying the sum of amounts paid by the purchaser 3 within the order calculation period of time by the dividend distribution rate by the purchaser distribution rate to calculate the purchaser dividend, and transfer the purchaser dividend to the cyber money account of the purchaser 3 (at step S240). The dividend distribution unit 160 may distribute the priority member dividend which is the remaining amount after subtracting the purchaser dividend from the dividend generated by the purchaser 3 to the priority members (that is, the purchaser 1 and the purchaser 2) who rank ahead the purchaser 3 and the purchaser 3 according to the priority member distribution method (at step S240).

Under the above-mentioned manner, the priority member dividends generated by the respective purchasers are distributed to the priority members who rank ahead the purchasers and the purchasers. The purchaser dividends and the priority member dividends are withdrawn from the amount kept in the system account unit 170 and are transferred to the cyber money accounts of the purchasers. The purchaser dividends and the priority member dividends are paid in cyber money, but it is possible that those are transferred in cash to the cash accounts of the purchasers.

Although, the steps S210 to 240 are explained to be sequentially performed, the steps may be performed concurrently or in a reverse sequence to the explained.

The order calculation unit 150 may determine second distribution order which is made by updating the first distribution order on the basis of the amounts of cyber money transferred to the cyber money accounts of the purchasers and the priority members (at step S250), and next, the steps S150 to S240 are repeated. The second distribution order is used as a dividend distribution standard for a second order calculation period of time. Updating the distribution order is performed whenever the order calculation period of time ends and is finished in accordance with the finish of the event.

In the product sales promotion system and method according to the first embodiment of the disclosed technology, the priority member distribution method is freely determined by the seller or the system. A desirable example of the priority member distribution method may be as follows.

The dividend distribution unit 160 may arrange the priority members and the purchasers in the order of the distribution. Next, a first individual priority member dividend calculated by multiplying the priority member dividend by the priority member distribution rate is paid to a first priority member who is the first in distribution order, and a second individual priority member dividend calculated by multiplying the amount remaining after subtracting the first individual priority member dividend from the priority member dividend by the priority member distribution rate is paid to a second priority member who is the second in the distribution order.

In this example, only the first and second priority members are exemplified, but in the same manner as above, the individual priority member dividends may be paid to the priority members who are next to the first and second priority members. For example, a third individual priority member dividend calculated by multiplying the amount remaining after subtracting the first individual priority member dividend and the second individual priority member dividend from the priority member dividend by the priority member distribution rate is paid to a third priority member who is the third in the distribution order.

If the priority member dividend remains even after the individual priority member dividends are paid to all of the priority members and the purchasers, the priority member dividend calculated by multiplying the remaining priority member dividend by the priority member distribution rate may be paid in the order of the priority members in the same manner as above. However, if the remaining priority member dividend is less than a given amount, the dividend distribution unit 160 may transfer the remaining priority member dividend to the system account unit 170 and finish the priority member dividend distribution.

According to another desirable example of the priority member distribution method, the priority member dividend may be divided into N (wherein N=the number of priority members+1), and the divided priority member dividends may be paid equally to the priority members and the purchaser.

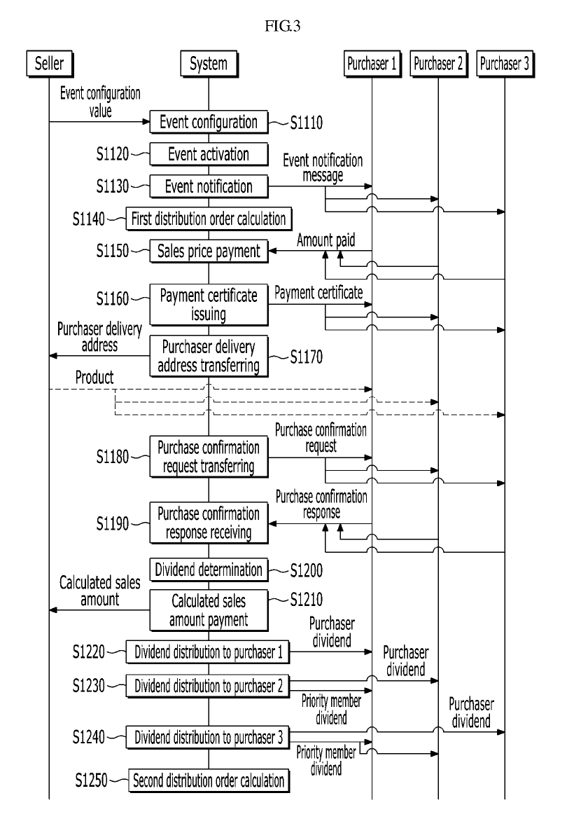

Now, a product sales promotion system and method according to a second embodiment of the disclosed technology will be described in detail with reference to the attached drawing. FIG. 3 is a flowchart showing processes of selling the products and distributing the dividend in the product sales promotion system according to the second embodiment of the disclosed technology.

The seller is connected to the product sales promotion system 100 by using the seller terminal 10, and he or she selects an event configuration menu so as to set an event through which the dividend corresponding to a portion of the paid sales price is distributed to purchasers and other members. The event configuration unit 110 displays, on the seller terminal 10, an input screen where, as event configuration values, a product category, a product name, the number of products to be sold, a period of time for product sales, a usage period of a product, a sales price of a product, a dividend distribution rate, a purchaser distribution rate, a priority member distribution rate, and an order calculation period of time, and so on are inputted, and the seller inputs, on the seller terminal 10, the event configuration values as required through the seller terminal 10. The event configuration values inputted to the event configuration unit 110 through the seller terminal 10 are stored in the event configuration unit 110, thereby completing setting the event (at step S1110).

The event configuration values may be arbitrarily determined by the seller, and some of them may be suggested with appropriate values by means of the product sales promotion system 100. Further, some of them are in advance calculated as optimized values by means of the product sales promotion system 100 and provided as fixed values.

The event may be finished if the products to be sold are completely sold or the period of time for product sales ends, and it is possible that the number of products to be sold and the period of time for product sales are not set. The usage period of a product means a period of time during which a product (for example, coupon) can be effectively used. The sales price of the product may be a normal retail price of the product or a price discounted by a discount rate arbitrarily determined by the seller. The dividend distribution rate, the purchaser distribution rate, the priority member distribution rate, and the order calculation period are will be explained later.

The event management unit 120 activates the event set on the event configuration unit 110 by the seller through the seller terminal 10 (at step S1120).

If the event is activated, the event management unit 120 transmits an event notification message to the terminals of the members joined in the product sales promotion system 100 (at step S1130). The members may register the products in which they are interested on member information, and the event management unit 120 may transmit the event notification message only to the members who have registered the products under the event as their interested products.

The order calculation unit 150 calculates first distribution order on the basis of the time when the event is activated (at step S1140). The first distribution order is the member order determined according to the amounts of cyber money deposited in the cyber money accounts of the members joined in the product sales promotion system 100. In this case, the members may change cash into cyber money and deposit the cyber money into the cyber money accounts, thereby increasing the amounts of cyber money in the cyber money accounts.

For the conveniences of the description, only purchasers 1, 2 and 3 are illustrated in FIG. 3, and the exemplary case wherein their first distribution order is determined in the order of the purchasers 1, 2 and 3 will be explained below. Further, the step S1140 is carried out before step S1150 of making a payment for the sales price, but there is no restriction in the processing sequence only if the step S1140 is carried out before the dividend distribution (Steps S1220 to S1240) to the purchasers.

So as to purchase the product, the purchaser makes a payment for the sales price of the product on the payment screen provided on the purchaser terminal 20 by the product payment unit 130 (at step S1150), and the paid amount for the sales price is deposited into the system account unit 170. The payment may be made by the cash withdrawn from the cyber money account or cash account of the purchaser, the card sales amount received from a credit card company of the purchaser, and the payment amount received from a smart phone communication company of the purchaser. The payment may be made by any known online payment methods, and a detailed explanation on the payment methods will be omitted.

If the payment for the product is made, the event management unit 120 issues a payment certificate and transfers the payment certificate to the purchaser terminal 20 (at step S1160). The payment certificate may have a form of an electronic image.

The delivery management unit 180 may transmit a delivery address and a payment certificate of the purchaser who makes a payment for the sales price of the product to the seller terminal 10 to allow the seller to deliver the product to the purchaser (at step S1170). A delivery method may include a delivery service and a direct delivery to the purchaser, and if the product is delivered directly to the purchaser, the seller scans bar codes on the payment certificate provided by the purchaser. After the purchaser is identified, accordingly, the product is taken over to the purchaser.

The purchase confirmation management unit 190 may transmit a purchase confirmation request to the purchaser who receives the product through the delivery service or directly receives the product from the seller (at step S1180).

The purchase confirmation management unit 190 may receive the response to the purchase confirmation request from the purchaser (at step S1190). The response to the purchase confirmation request is either a purchase confirmation response or a purchase cancel response. If the response to the purchase confirmation request is the purchase cancel response, the event management unit 120 pays the paid amount as a refund to the purchaser who transmits the purchase cancel response. The refund is withdrawn from the amount kept in the system account unit 170 and is thus transferred to the cash account of the purchaser who transmits the purchase cancel response. Hereinafter, an explanation on the case where the response to the purchase confirmation request is the purchase confirmation response will be in detail given.

If the order calculation period of time end after the event is activated, the dividend distribution unit 160 multiplies the sum of paid amounts of the purchaser who performs the purchase confirmation response within the order calculation period of time by the dividend distribution rate to determine the dividend generated by the purchaser (at step S1200). A first part of the dividend is distributed to the whole or some of the priority members who ranks ahead the purchaser in the first distribution order according to a predetermined priority member distribution method, and a second part of the dividend is distributed to the purchasers. Desirably, the sum of the first part and the second part of the dividend is the same as the dividend of total. The dividends are transferred to the cyber money accounts of the purchasers and the priority members. According to the second embodiment of the disclosed technology, the dividend (the second part of the dividend) distributed to the purchaser is called “purchaser dividend”. The dividends distributed to the whole or some of the priority members according to the priority member distribution method, which are the amounts calculated by subtracting the purchaser dividends from the dividends, are called “priority member dividend”, and the priority member dividend distributed to individual of the priority members is called “individual priority member dividend”. The individual priority member dividends are transferred to the cyber money accounts of the whole or some of the priority members in the form of cyber money.

The distribution order may be calculated with respect to the all members joined in the product sales promotion system 100 or for only the purchasers who purchase the products sold through the event.

The order calculation period of time may be set with a given period of time or in real time, and the given period of time may be set with a period of 12 hours, one day, or one week. If the order calculation period of time ends, the distribution order is updated. If the order calculation period of time is set in real time, the distribution order is updated right after the payments and purchase confirmation of the purchasers are finished.

The event management unit 120 may pay the amount of product sales calculated by subtracting the dividends from the total amount of product sales (which is calculated by multiplying the sales price by the number of purchase confirmed products) to the cash account of the seller (at step S1210).

The priority member distribution range means the range of the priority members who receive the distribution among the priority members, and “distribution to the all priority members” and “distribution to some of the priority members” may be selected by the seller or the system. Hereinafter, an explanation on the exemplary case where the dividend distribution unit 160 pays the priority member dividend to the all priority members will be given.

The dividend distribution unit 160 may multiply the dividend calculated by multiplying the sum of amounts paid by the purchaser 1 within the order calculation period of time by the dividend distribution rate by the purchaser distribution rate to calculate the purchaser dividend, and transfers the purchaser dividend to the cyber money account of the purchaser 1 (at step S1220). With respect to the distribution of the priority member dividend which is the remaining amount calculated by subtracting the purchaser dividend from the dividend generated by the purchaser 1, there is no priority member who ranks ahead the purchaser 1, the top priority member, and accordingly, the priority member dividend is transferred to the system account unit 170.

The dividend distribution unit 160 may multiply the dividend calculated by multiplying the sum of amounts paid by the purchaser 2 within the order calculation period of time by the dividend distribution rate by the purchaser distribution rate to calculate the purchaser dividend, and transfer the purchaser dividend to the cyber money account of the purchaser 2 (at step S1230). The dividend distribution unit 160 may distribute the priority member dividend which is the remaining amount after subtracting the purchaser dividend from the dividend generated by the purchaser 2 to the purchaser 1 as the priority member who ranks ahead the purchaser 2 according to the priority member distribution method (at step S1230).

The dividend distribution unit 160 may multiply the dividend calculated by multiplying the sum of amounts paid by the purchaser 3 within the order calculation period of time by the dividend distribution rate by the purchaser distribution rate to calculate the purchaser dividend, and transfer the purchaser dividend to the cyber money account of the purchaser 3 (at step S1240). The dividend distribution unit 160 may distribute the priority member dividend which is the remaining amount after subtracting the purchaser dividend from the dividend generated by the purchaser 3 to the purchaser 1 and the purchaser 2 as the priority members who rank ahead the purchaser 3 according to the priority member distribution method (at step S1240).

Under the above-mentioned manner, the priority member dividends generated by the respective purchasers are distributed to the all priority members who rank ahead the purchasers. The purchaser dividends and the priority member dividends are withdrawn from the amount kept in the system account unit 170 and are transferred to the cyber money accounts of the purchasers. The purchaser dividends and the priority member dividends are paid in cyber money, but it is possible that those are transferred in cash to the cash accounts of the purchasers.

Although, the steps S1210 to 1240 are explained to be sequentially performed, the steps may be performed concurrently or in a reverse sequence to the explained.

The order calculation unit 150 may determine second distribution order which is made by updating the first distribution order on the basis of the amounts of cyber money transferred to the cyber money accounts of the purchasers and the priority members (at step S1250), and next, the steps S1150 to S1240 are repeated. The second distribution order is used as a dividend distribution standard for a second order calculation period of time. Updating the distribution order is performed whenever the order calculation period of time ends and is finished in accordance with the finish of the event.

Further, the dividend distribution unit 160 may distribute the priority member dividend only to some of the priority members. In this case, the some of the priority members are selected according to the distribution order in the order from the top priority member or are randomly selected.

An exemplary case where some of the priority members are selected as the priority member distribution range according to the distribution order from the top priority member will be explained. For example, the priority member dividend generated by the purchase who is the 100th in the distribution order is not distributed to all of the 99 priority members, but after some of the priority members such as the priority members who are first to 70th, first to 50th, or first to 30th are firstly selected, the priority member dividends may be distributed only to the selected priority members according to the priority member distribution method on the basis of the distribution order.

An exemplary case where some of the priority members are randomly selected as the priority member distribution range will be explained. For example, the priority member dividend generated by the purchase of the purchaser who is the 100th in the distribution order is not distributed to all of the 99 priority members, but after 70, 50, or 30 priority members who are randomly selected from the 99 priority members, the priority member dividends are distributed only to the selected priority members according to the priority member distribution method on the basis of the distribution order.

In the product sales promotion system and method according to the second embodiment of the disclosed technology, the priority member distribution method is freely determined by the seller or the system. A desirable example of the priority member distribution method is the same as mentioned in the first embodiment of the disclosed technology.

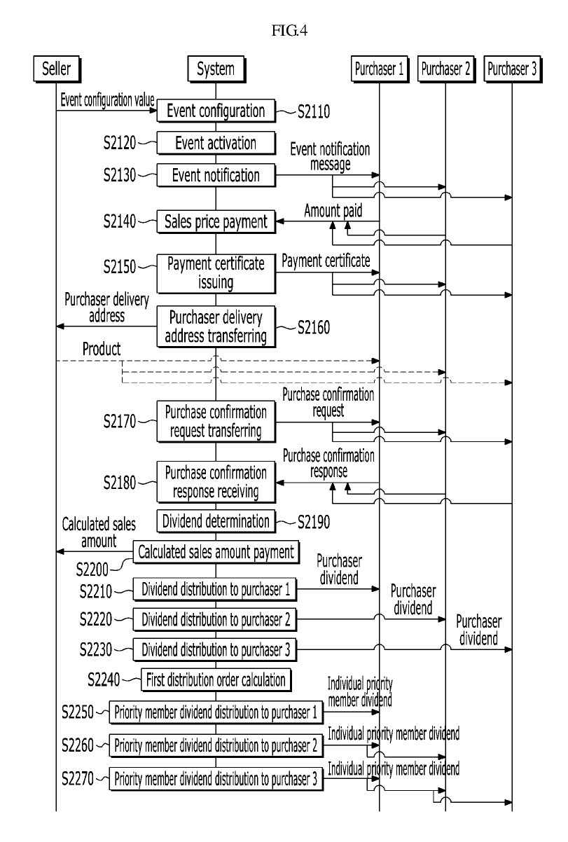

Now, a product sales promotion system and method according to a third embodiment of the disclosed technology will be described in detail with reference to the attached drawing. FIG. 4 is a flowchart showing processes of selling the products and distributing the dividend in the product sales promotion system according to the third embodiment of the disclosed technology.

The seller is connected to the product sales promotion system 100 by using the seller terminal 10, and he or she selects an event configuration menu so as to set an event through which the dividend corresponding to a portion of the paid sales price paid is distributed to purchasers and other members. The event configuration unit 110 displays, on the seller terminal 10, an input screen where, as event configuration values, a product category, a product name, the number of products to be sold, a period of time for product sales, a usage period of a product, a sales price of a product, a dividend distribution rate, a purchaser distribution rate, a priority member distribution rate, and an order calculation period of time, and so on are inputted, and the seller inputs, on the seller terminal 10, the event configuration values as required through the seller terminal 10. The event configuration values inputted to the event configuration unit 110 through the seller terminal 10 are stored in the event configuration unit 110, thereby completing setting the event (at step S2110).

The event configuration values may be arbitrarily determined by the seller, and some of them may be suggested with appropriate values by means of the product sales promotion system 100. Further, some of them are in advance calculated as optimized values by means of the product sales promotion system 100 and provided as fixed values.

The event is finished if the products to be sold are completely sold or the period of time for product sales ends, and it is possible that the number of products to be sold and the period of time for product sales are not set. The usage period of a product means a period of time during which a product (for example, coupon) can be effectively used. The sales price of the product may be a normal retail price of the product or a price discounted by a discount rate arbitrarily determined by the seller. The dividend distribution rate, the purchaser distribution rate, the priority member distribution rate, and the order calculation period are will be explained later.

The event management unit 120 activates the event set on the event configuration unit 110 by the seller through the seller terminal 10 (at step S2120).

If the event is activated, the event management unit 120 transmits an event notification message to the terminals of the members joined in the product sales promotion system 100 (at step S2130). The members may register the products in which they are interested on member information, and the event management unit 120 may transmit the event notification message only to the members who have registered the products under the event as their interested products.

For the conveniences of the description, only purchasers 1, 2 and 3 are illustrated in FIG. 4, and the exemplary case wherein their first distribution order is determined in the order of the purchasers 1, 2 and 3 will be explained below.

So as to purchase the product, the purchaser makes a payment for the sales price of the product on the payment screen provided on the purchaser terminal 20 by the product payment unit 130 (at step S2140), and the paid amount for the sales price is deposited into the system account unit 170. The payment may be made by the cash withdrawn from the cyber money account or cash account of the purchaser, the card sales amount received from a credit card company of the purchaser, and the payment amount received from a smart phone communication company of the purchaser. The payment may be made by any known online payment methods, and a detailed explanation on the payment methods will be omitted.

If the payment for the product is made, the event management unit 120 issues a payment certificate and transfers the payment certificate to the purchaser terminal 20 (at step S2150). The payment certificate may have a form of an electronic image.

The delivery management unit 180 may transmit a delivery address and a payment certificate of the purchaser who makes a payment for the sales price of the product to the seller terminal 10 to allow the seller to deliver the product to the purchaser (at step S2170). A delivery method may include a delivery service and a direct delivery to the purchaser, and if the product is delivered directly to the purchaser, the seller scans bar codes on the payment certificate provided by the purchaser. After the purchaser is identified, accordingly, the product is taken over to the purchaser.

The purchase confirmation management unit 190 may transmit a purchase confirmation request to the purchaser who receives the product through the delivery service or directly receives the product from the seller (at the step S2170).

The purchase confirmation management unit 190 may receive the response to the purchase confirmation request from the purchaser (at step S2180). The response to the purchase confirmation request is either a purchase confirmation response or a purchase cancel response. If the response to the purchase confirmation request is the purchase cancel response, the event management unit 120 pays the paid amount as a refund to the purchaser who transmits the purchase cancel response. The refund is withdrawn from the amount kept in the system account unit 170 and is thus transferred to the cash account of the purchaser who transmits the purchase cancel response. Hereinafter, an explanation on the case where the response to the purchase confirmation request is the purchase confirmation response will be in detail given.

If a first order calculation period of time end after the event is activated, the dividend distribution unit 160 multiplies the sum of paid amounts of the purchaser who performs the purchase confirmation response within the first order calculation period of time by the dividend distribution rate to determine the dividend generated by the purchaser (at step S2190).

The order calculation period of time may be set with a given period of time or in real time, and the given period of time is set with a period of 12 hours, one day, or one week. If the order calculation period of time ends, the distribution order is updated. If the order calculation period of time is set in real time, the distribution order is updated instantly right the payments and purchase confirmation of the purchasers are finished.

The event management unit 120 may pay the amount of product sales calculated by subtracting the dividends from the total amount of product sales (which is calculated by multiplying the sales price by the number of purchase confirmed products) to the cash account of the seller (at step S2200).

A second part of the dividend, which is a portion of the dividend determined at the step S2190, is firstly distributed to the purchaser. According to the third embodiment of the disclosed technology, the dividend (the second part of the dividend) distributed to the purchaser is called “purchaser dividend”.

The dividend distribution unit 160 may multiply the dividend calculated by multiplying the sum of amounts paid by the purchaser 1 within the first order calculation period of time by the dividend distribution rate by the purchaser distribution rate to calculate the purchaser dividend, and transfers the purchaser dividend to the cyber money account of the purchaser 1 (at step S2210).

The dividend distribution unit 160 may multiply the dividend calculated by multiplying the sum of amounts paid by the purchaser 2 within the first order calculation period of time by the dividend distribution rate by the purchaser distribution rate to calculate the purchaser dividend, and transfer the purchaser dividend to the cyber money account of the purchaser 2 (at step S2220).

The dividend distribution unit 160 may multiply the dividend calculated by multiplying the sum of amounts paid by the purchaser 3 within the first order calculation period of time by the dividend distribution rate by the purchaser distribution rate to calculate the purchaser dividend, and transfer the purchaser dividend to the cyber money account of the purchaser 3 (at step S2230).

Although the steps S2210 to 2230 are explained to be sequentially performed, the steps may be performed concurrently or in a reverse sequence to the explained.

The order calculation unit 150 may determine first distribution order by reflecting the purchaser dividends distributed to the purchasers (at step S2240). The distribution order is determined according to the amounts of cyber money deposited in the cyber money accounts of the members joined in the product sales promotion system 100. The first distribution order is determined by adding the purchaser dividends distributed to the purchasers for the first order calculation period of time to the amounts of cyber money deposited in the cyber money accounts of the members before the activation of the event. In this case, the members may change cash into cyber money and deposit the cyber money into the cyber money accounts, thereby increasing the cyber money amounts of the cyber money accounts.

The remaining dividend (a first part) calculated by subtracting the purchaser dividend from the dividend determined at the step S2190 is distributed to the members (hereinafter, referred to as “priority members”) who rank ahead the purchaser in the first distribution order and the purchasers according to a predetermined priority member distribution method. According to the third embodiment of the disclosed technology, the dividend (the first part of the dividend) distributed to each of the priority members and the purchasers according to the priority member distribution method, which is the amount calculated by subtracting the purchaser dividend from the dividend, is called “priority member dividend”, and the priority member dividend distributed to individual of the priority members is called “individual priority member dividend”. The individual priority member dividends are transferred to the cyber money accounts of the purchasers and the priority members in the form of cyber money.

The recipients of the priority member dividends may be selected among the all members joined in the product sales promotion system 100 or only among the purchasers who purchase the products sold through the event. That is, the distribution order may be calculated with respect to the all members or only the purchasers who purchase the products sold through the event.

If the first distribution order is determined, the dividend distribution unit 160 may distribute the priority member dividend which is the remaining amount after subtracting the purchaser dividend from the dividend generated by the purchaser 1 to the priority members who rank ahead the purchaser 1 and the purchaser 1 according to the priority member distribution method. However, because there is no priority member who ranks ahead the purchaser 1, the priority member dividend is distributed only to the purchaser 1 as the top priority member (at step S2250).

The dividend distribution unit 160 may distribute the priority member dividend which is the remaining amount after subtracting the purchaser dividend from the dividend generated by the purchaser 2 to the priority member (that is, the purchaser 1) who ranks ahead the purchaser 2 and the purchaser 2 according to the priority member distribution method (at step S2260).

The dividend distribution unit 160 may distribute the priority member dividend which is the remaining amount after subtracting the purchaser dividend from the dividend generated by the purchaser 3 to the priority members (that is, the purchaser 1 and the purchaser 2) who rank ahead the purchaser 3 and the purchaser 3 according to the priority member distribution method (at step S2270).

The purchaser dividends and the priority member dividends are withdrawn from the amount kept in the system account unit 170 and are transferred to the cyber money accounts of the purchasers. The purchaser dividends and the priority member dividends are paid in cyber money, but it is possible that those are transferred in cash to the cash accounts of the purchasers.

Next, a second order calculation period of time starts, and the steps S2140 to S2230 are repeated. Second distribution order used for the distribution of the priority member dividends for the second order calculation period of time is determined on the basis of the individual priority member dividends transferred to the cyber money accounts of the purchasers within the first order calculation period of time and the purchaser dividends transferred to the cyber money accounts of the purchasers within the second order calculation period of time. Updating the distribution order is performed in the above manner whenever the order calculation periods of time end.

In the product sales promotion system and method according to the third embodiment of the disclosed technology, the priority member distribution method is freely determined by the seller or the system. A desirable example of the priority member distribution method is the same as mentioned in the first embodiment of the disclosed technology.

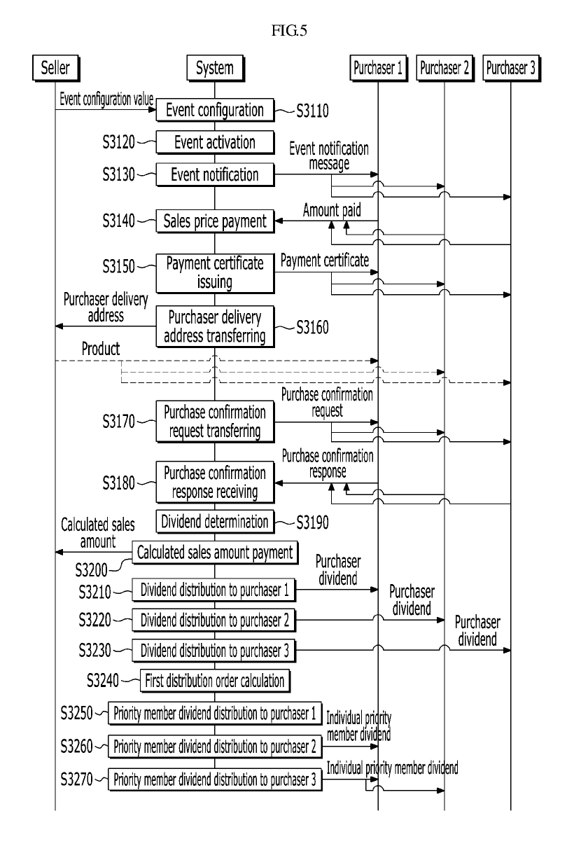

Now, a product sales promotion system and method according to a fourth embodiment of the disclosed technology will be described in detail with reference to the attached drawing. FIG. 5 is a flowchart showing processes of selling the products and distributing the dividend in the product sales promotion system according to the fourth embodiment of the disclosed technology.

The seller is connected to the product sales promotion system 100 by using the seller terminal 10, and he or she selects an event configuration menu so as to set an event through which the dividend corresponding to a portion of the paid sales price is distributed to purchasers and other members. The event configuration unit 110 displays, on the seller terminal 10, an input screen where, as event configuration values, a product category, a product name, the number of products to be sold, a period of time for product sales, a usage period of a product, a sales price of a product, a dividend distribution rate, a purchaser distribution rate, a priority member distribution rate, and an order calculation period of time, and so on are inputted, and the seller inputs, on the seller terminal 10, the event configuration values as required through the seller terminal 10. The event configuration values inputted to the event configuration unit 110 through the seller terminal 10 are stored in the event configuration unit 110, thereby completing setting the event (at step S3110).

The event configuration values may be arbitrarily determined by the seller, and some of them may be suggested with appropriate values by means of the product sales promotion system 100. Further, some of them are in advance calculated as optimized values by means of the product sales promotion system 100 and provided as fixed values.

The event may be finished if the products to be sold are completely sold or the period of time for product sales ends, and it is possible that the number of products to be sold and the period of time for product sales are not set. The usage period of a product means a period of time during which a product (for example, coupon) can be effectively used. The sales price of the product may be a normal retail price of the product or a price discounted by a discount rate arbitrarily determined by the seller. The dividend distribution rate, the purchaser distribution rate, the priority member distribution rate, and the order calculation period are will be explained later.

The event management unit 120 activates the event set on the event configuration unit 110 by the seller through the seller terminal 10 (at step S3120).

If the event is activated, the event management unit 120 transmits an event notification message to the terminals of the members joined in the product sales promotion system 100 (at step S3130). The members may register the products in which they are interested on member information, and the event management unit 120 may transmit the event notification message only to the members who have registered the products under the event as their interested products.

For the conveniences of the description, only purchasers 1, 2 and 3 are illustrated in FIG. 5, and the exemplary case wherein their first distribution order is determined in the order of the purchasers 1, 2 and 3 will be explained below.

So as to purchase the product, the purchaser makes a payment for the sales price of the product on the payment screen provided on the purchaser terminal 20 by the product payment unit 130 (at step S3140), and the paid amount for the sales price is deposited into the system account unit 170. The payment may be made by the cash withdrawn from the cyber money account or cash account of the purchaser, the card sales amount received from a credit card company of the purchaser, and the payment amount received from a smart phone communication company of the purchaser. The payment may be made by any known online payment methods, and a detailed explanation on the payment methods will be omitted.

If the payment for the product is made, the event management unit 120 issues a payment certificate and transfers the payment certificate to the purchaser terminal 20 (at step S3150). The payment certificate may have a form of an electronic image.

The delivery management unit 180 may transmit a delivery address and a payment certificate of the purchaser who makes a payment for the sales price of the product to the seller terminal 10 to allow the seller to deliver the product to the purchaser (at step S3170). A delivery method may include a delivery service and a direct delivery to the purchaser, and if the product is delivered directly to the purchaser, the seller scans bar codes on the payment certificate provided by the purchaser. After the purchaser is identified, accordingly, the product is taken over to the purchaser.

The purchase confirmation management unit 190 may transmit a purchase confirmation request to the purchaser who receives the product through the delivery service or directly receives the product from the seller (at step S3170).

The purchase confirmation management unit 190 may receive the response to the purchase confirmation request from the purchaser (at step S3180). The response to the purchase confirmation request is either a purchase confirmation response or a purchase cancel response. If the response to the purchase confirmation request is the purchase cancel response, the event management unit 120 pays the paid amount as a refund to the purchaser who transmits the purchase cancel response. The refund is withdrawn from the amount kept in the system account unit 170 and is thus transferred to the cash account of the purchaser who transmits the purchase cancel response. Hereinafter, an explanation on the case where the response to the purchase confirmation request is the purchase confirmation response will be in detail given.

If a first order calculation period of time end after the event is activated, the dividend distribution unit 160 multiplies the sum of paid amounts of the purchaser who performs the purchase confirmation response within the first order calculation period of time and the dividend distribution rate to determine the dividend generated by the purchaser (at step S3190).

The order calculation period of time may be set with a given period of time or in real time, and the given period of time may be set with a period of 12 hours, one day, or one week. If the order calculation period of time ends, the distribution order is updated. If the order calculation period of time is set in real time, the distribution order is updated right after the payments and purchase confirmation of the purchasers are finished.

The event management unit 120 may pay the amount of product sales calculated by subtracting the dividends from the total amount of product sales (which is calculated by multiplying the sales price by the number of purchase confirmed products) to the cash account of the seller (at step S3200).

A second part of the dividend, which is a portion of the dividend determined at the step S3190, is firstly distributed to the purchaser. According to the fourth embodiment of the disclosed technology, the dividend (the second part of the dividend) distributed to the purchaser is called “purchaser dividend”.

The dividend distribution unit 160 may multiply the dividend calculated by multiplying the sum of amounts paid by the purchaser 1 within the first order calculation period of time by the dividend distribution rate by the purchaser distribution rate to calculate the purchaser dividend, and transfers the purchaser dividend to the cyber money account of the purchaser 1 (at step S3210).

The dividend distribution unit 160 may multiply the dividend calculated by multiplying the sum of amounts paid by the purchaser 2 within the first order calculation period of time by the dividend distribution rate by the purchaser distribution rate to calculate the purchaser dividend, and transfers the purchaser dividend to the cyber money account of the purchaser 2 (at step S3220).

The dividend distribution unit 160 may multiply the dividend calculated by multiplying the sum of amounts paid by the purchaser 3 within the first order calculation period of time by the dividend distribution rate by the purchaser distribution rate to calculate the purchaser dividend, and transfers the purchaser dividend to the cyber money account of the purchaser 3 (at step S3230).

Although, the steps S3210 to 3230 are explained to be sequentially performed, the steps may be performed concurrently or in a reverse sequence to the explained.

The order calculation unit 150 may determine the first distribution order by reflecting the purchaser dividends distributed to the purchasers (at step S3240). The distribution order is determined according to the amounts of cyber money deposited in the cyber money accounts of the members joined in the product sales promotion system 100. The first distribution order is determined by adding the purchaser dividends distributed to the purchasers for the first order calculation period of time to the amounts of cyber money deposited in the cyber money accounts of the members before the activation of the event. In this case, the members may change cash into cyber money and deposit the cyber money into the cyber money accounts, thereby increasing the cyber money amounts of the cyber money accounts.

The remaining dividend (a first part) calculated by subtracting the purchaser dividend from the dividend determined at the step S3190 is distributed to the whole or some of the members (hereinafter, referred to as “priority members”) who rank ahead the purchaser in the first distribution order according to a predetermined priority member distribution method. According to the fourth embodiment of the disclosed technology, the dividend (the first part of the dividend) distributed to each of the whole or some of priority members according to the priority member distribution method, which is the amount calculated by subtracting the purchaser dividend from the dividend, is called “priority member dividend”, and the priority member dividend distributed to individual of the priority members is called “individual priority member dividend”. The individual priority member dividends are transferred to the cyber money accounts of the whole or some of priority members in the form of cyber money.

The distribution order may be calculated with respect to the all members joined in the product sales promotion system 100 or only the purchasers who purchase the products sold through the event.

The priority member distribution range means the range of the priority members who receive the distribution among the priority members, and “distribution to the all priority members” and “distribution to some of the priority members” may be selected by the seller or the system. Hereinafter, an explanation on the exemplary case where the dividend distribution unit 160 pays the priority member dividend to the all priority members will be given.

If the first distribution order is determined, the dividend distribution unit 160 may distribute the priority member dividend which is the remaining amount after subtracting the purchaser dividend from the dividend generated by the purchaser 1 to the priority members who rank ahead the purchaser 1 according to the priority member distribution method. However, because there is no priority member who ranks ahead the purchaser 1, the priority member dividend is transferred to the system account unit 170 (at step S3250).

The dividend distribution unit 160 may distribute the priority member dividend which is the remaining amount after subtracting the purchaser dividend from the dividend generated by the purchaser 2 to the priority member (that is, the purchaser 1) who ranks ahead the purchaser 2 according to the priority member distribution method (at step S3260).

The dividend distribution unit 160 may distribute the priority member dividend which is the remaining amount after subtracting the purchaser dividend from the dividend generated by the purchaser 3 to the priority members (that is, the purchaser 1 and the purchaser 2) who rank ahead the purchaser 3 according to the priority member distribution method (at step S3270).

The purchaser dividends and the priority member dividends are withdrawn from the amount kept in the system account unit 170 and are transferred to the cyber money accounts of the purchasers and the priority members. The purchaser dividends and the priority member dividends are paid in cyber money, but it is possible that those are transferred in cash to the cash accounts of the purchasers and the priority members.

Next, a second order calculation period of time starts, and the steps S3140 to S3230 are repeated. Second distribution order used for the distribution of the priority member dividends for the second order calculation period of time is determined on the basis of the individual priority member dividends transferred to the cyber money accounts of the priority members within the first order calculation period of time and the purchaser dividends transferred to the cyber money accounts of the purchasers within the second order calculation period of time. Updating the distribution order is performed in the above manner whenever the order calculation periods of time end.

Further, the dividend distribution unit 160 may distribute the priority member dividends only to some of the priority members. In this case, the some of the priority members are selected according to the distribution order in the order from the top priority member, or are randomly selected.

In the product sales promotion system and method according to the fourth embodiment of the disclosed technology, the priority member distribution method is freely determined by the seller or the system. A desirable example of the priority member distribution method is the same as mentioned in the first embodiment of the disclosed technology.

If the purchasers purchase the products during the event through the product sales promotion system and method according to the embodiments of the disclosed technology, the purchaser dividends and the priority member dividends are continuously distributed, so that the assets of the purchasers are increased through their purchase and the purchase of other members. Now, the effects obtained by the system and method according to the disclosed technology will be explained with an exemplary case.

A seller A who sells clothing in America determines to sell 7 kinds of clothes at the lowest price on online through the product sales promotion system 100 according to the embodiment of FIG. 1, and the sales prices of the 7 kinds of clothes to be sold by the seller A are 5, 8, 10, 20, 50, 100 and 200 dollars respectively. The following event configuration values are inputted by the seller A.
Target period of product sales: three days
Order calculation period of time: one day
Dividend distribution rate: 10%
Purchaser distribution rate: 40%
Priority member distribution method: Even distribution to N including purchasers

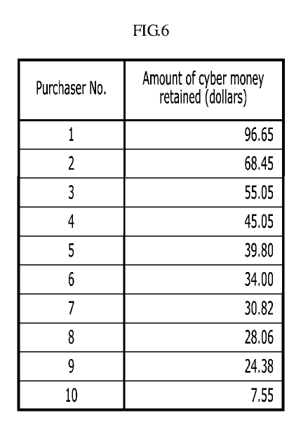

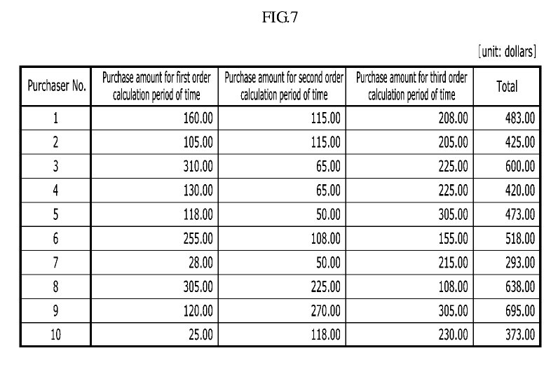

The first distribution order is determined according to the amounts of cyber money deposited in the cyber money accounts of 10 purchasers, and the amounts of cyber money of the 10 purchasers and the first distribution order determined according to the amounts of cyber money of the 10 purchasers are listed in FIG. 6. The 10 purchasers randomly purchase three pieces of clothing every day for three days, and the purchase amounts of the 10 purchasers by one day are listed in FIG. 7.

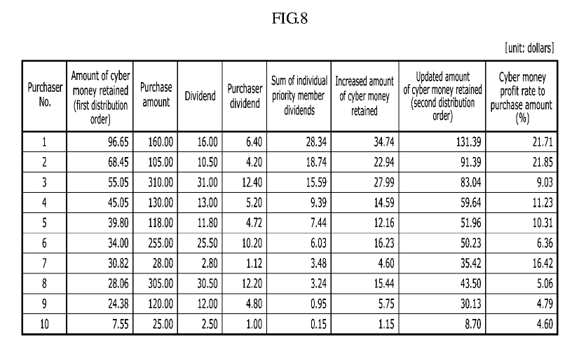

FIG. 8 shows the amounts distributed to the purchasers for the first order calculation period of time.

The purchaser 1 is the first ranker in the first distribution order and buys 160 dollars clothing within the first order calculation period of time. As soon as the first order calculation period of time ends, 16.00 dollars corresponding to 10% (dividend distribution rate) of 160 dollars paid by the purchaser 1 is determined as the dividend generated by the purchaser 1. Next, 6.40 dollars, as a purchaser dividend, corresponding to 40% (purchaser distribution rate) of the dividend is transferred to the cyber money account of the purchaser 1, and 9.60 dollars corresponding to the amount calculated by subtracting the purchaser dividend from the dividend is transferred only to the cyber money account of the purchaser 1 because there is no priority member who ranks ahead the purchaser 1. Also, the priority member dividend is calculated by subtracting the purchaser dividend from the dividend corresponding to 10% (dividend distribution rate) of the amount paid by each of the purchasers 2 to 10, and the individual priority member dividend is the amount calculated by dividing the priority member dividend into the number of the purchaser and the priority members (that is, the amounts divided into N parts; N=the number of priority members+1). The individual priority member dividends are transferred to the cyber money account of the purchaser 1. That is, the purchaser 1 has 28.34 dollars as the sum of the individual priority member dividends (the priority member dividend of the purchaser 1 of 9.60 dollars, the individual priority member dividend of 3.15 dollars transferred from the purchaser 2, the individual priority member dividend of 6.20 dollars transferred from the purchaser 3, the individual priority member dividend of 1.95 dollars transferred from the purchaser 4, the individual priority member dividend of 1.42 dollars transferred from the purchaser 5, the individual priority member dividend of 2.55 dollars transferred from the purchaser 6, the individual priority member dividend of 0.24 dollars transferred from the purchaser 7, the individual priority member dividend of 2.29 dollars transferred from the purchaser 8, the individual priority member dividend of 0.80 dollars transferred from the purchaser 9, and the individual priority member dividend of 0.15 dollars transferred from the purchaser 10).

The purchaser 1 has purchased clothing of 160 dollars at the minimum price on online for the first order calculation period of time, so that his or her assets of 34.74 dollars (the sum of the purchaser dividend of 6.40 dollars and the sum of individual priority member dividends of 28.34 dollars) are increased. Also, a cyber money profit rate to the purchase amount of the purchaser 1 for the first order calculation period of time is 21.71%.

The purchaser 2 is the second ranker in the first distribution order and spends 105 dollars on clothing for the first order calculation period of time. As soon as the first order calculation period of time ends, 10.50 dollars corresponding to 10% (dividend distribution rate) of 105 dollars paid by the purchaser 2 is determined as the dividend generated by the purchaser 2. Next, 4.20 dollars, as a purchaser dividend, corresponding to 40% (purchaser distribution rate) of the dividend is transferred to the cyber money account of the purchaser 2, and 6.30 dollars corresponding to the amount calculated by subtracting the purchaser dividend from the dividend generated by the purchaser 2 is evenly distributed to the purchaser 1 who ranks ahead the purchaser 2 and the purchaser 2, so that 3.15 dollars are transferred to each of the purchaser 1 and the purchaser 2. Also, the priority member dividend is calculated by subtracting the purchaser dividend from the dividend corresponding to 10% (dividend distribution rate) of the amount paid by each of the purchasers 3 to 10, and the individual priority member dividend is the amount calculated by dividing the priority member dividend into the number of the purchaser and the priority members (that is, the amounts divided into N parts; N=the number of priority members+1). The individual priority member dividends are transferred to the cyber money account of the purchaser 2. That is, the purchaser 2 has 18.74 dollars as the sum of the individual priority member dividends (the individual priority member dividend of the purchaser 2 of 3.15 dollars, the individual priority member dividend of 6.20 dollars transferred from the purchaser 3, the individual priority member dividend of 1.95 dollars transferred from the purchaser 4, the individual priority member dividend of 1.42 dollars transferred from the purchaser 5, the individual priority member dividend of 2.55 dollars transferred from the purchaser 6, the individual priority member dividend of 0.24 dollars transferred from the purchaser 7, the individual priority member dividend of 2.29 dollars transferred from the purchaser 8, the individual priority member dividend of 0.80 dollars transferred from the purchaser 9, and the individual priority member dividend of 0.15 dollars transferred from the purchaser 10).

The purchaser 2 has purchased clothing with the amount less than the amount paid by the purchaser 1 for the first order calculation period of time, but a cyber money profit rate to the purchase amount of the purchaser 2 for the first order calculation period of time is 21.85%, which is higher than the cyber money profit rate to the purchase amount of the purchaser 1 of 21.71%. Further, the purchaser 7 has purchased clothing of 28 dollars for the first order calculation period of time, and that is, the 28 dollars are just the amount corresponding to 17.5% of the purchase amount of the purchaser 1. In this case, however, a cyber money profit rate to the purchase amount of the purchaser 7 is 16.42%. Therefore, the product sales promotion system according to the embodiment of the disclosed technology has different technical structures and effects from the conventional point saving system in which points proportional to purchase amounts are simply saved. Under the product sales promotion system according to the embodiment of the disclosed technology, even if the purchaser purchases the products with a relatively low purchase amount, his or her cyber money profit rate to the purchase amount can be higher than other purchasers.

Through such exceptionality of the cyber money profit rate to the purchase amount, even the low-rankers in the distribution order may expect that they may have the cyber money profit rate to the purchase amount higher than the high-rankers and may also expect that their ranking in the distribution order may be raised, so that all of the members who are joined in the product sales promotion system are promoted to purchase.

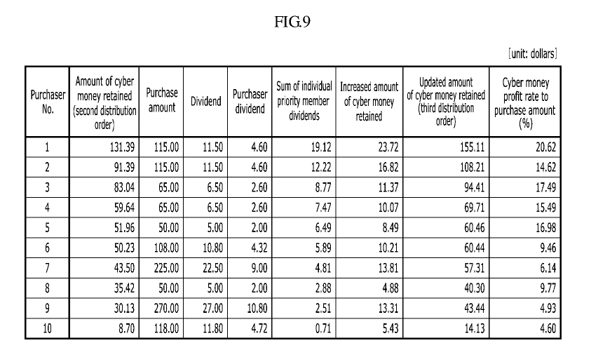

FIG. 9 shows the amounts to be distributed to the purchasers for the second order calculation period of time.

In the first distribution order, the amount of cyber money owned by the purchaser 7 is 30.82 dollars, and the amount of cyber money owned by the purchaser 8 is 28.06 dollars, so that the purchaser 7 ranks higher than the purchaser 8. After the dividend distribution for the first order calculation period of time, the amount of cyber money owned by the purchaser 7 is 35.42 dollars, and the amount of cyber money owned by the purchaser 8 is 43.50 dollars, so that the purchaser 8 becomes to rank higher than the purchaser 7 in the second distribution order which is the dividend distribution standard for the second order calculation period of time.

The purchaser 3 has purchased clothing of 65.00 dollars for the second order calculation period of time, and that is, the 65.00 dollars are just the amount corresponding to 56.5% of the purchase amount of 115.00 dollars of the purchaser 2. In this case, however, a cyber money profit rate to the purchase amount of the purchaser 3 is 17.49%, which is higher than the cyber money profit rate to the purchase amount of the purchaser 2 of 14.62%. In other words, even if the purchaser purchases the products with a relatively low purchase amount, his or her cyber money profit rate to the purchase amount may be higher than other purchasers. This feature also caused by the unique technical structures of the disclosed technology.

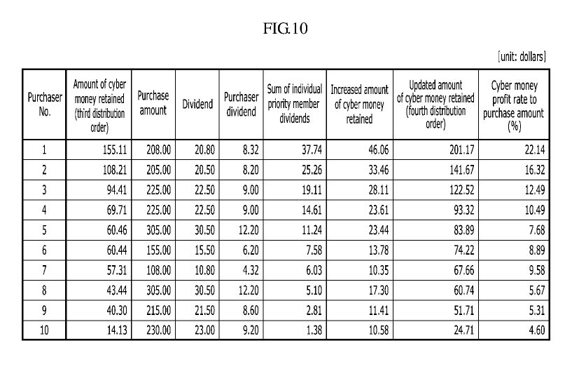

FIG. 10 shows the amounts to be distributed to the purchasers for the third order calculation period of time.

In the second distribution order, the amount of cyber money owned by the purchaser 7 is 35.42 dollars, and the amount of cyber money owned by the purchaser 9 is 30.13 dollars, so that the purchaser 7 ranks higher than the purchaser 9.

After the dividend distribution for the second order calculation period of time, the amount of cyber money owned by the purchaser 7 is 40.30 dollars, and the amount of cyber money owned by the purchaser 9 is 43.44 dollars, so that the purchaser 9 becomes to rank higher than the purchaser 7 in the third distribution order which is the dividend distribution standard for the third order calculation period of time.

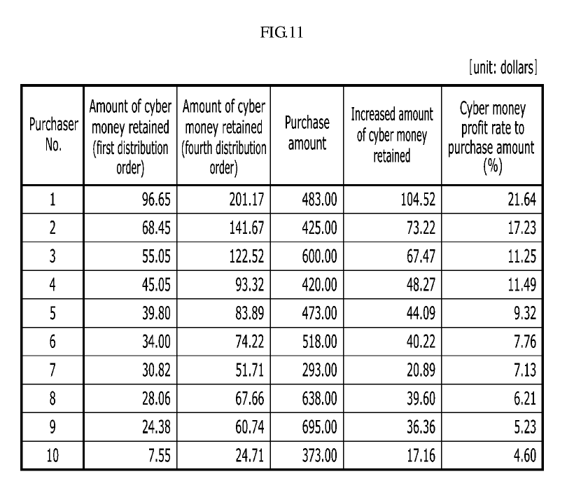

FIG. 11 is a table showing the cyber money profit rates to the purchase amounts of the purchasers during the event.

While the purchaser 1 owns the cyber money of 96.65 dollars before the event, he or she purchases 9 pieces of clothing at the minimum online price of 483.00 dollars during the event for three days and, additionally, the cyber money of the purchaser 1 is increased to 104.52 dollars. The cyber money profit rate to the purchase amount of the purchaser 1 is 21.64%. It is also confirmed that the amounts of cyber money of other purchasers are increased.

With a payment of the withdrawal fee, the cyber money may be transferred to the cash account from the cyber money account in the form of cash or may be withdrawn directly from the cyber money account in the form of cash, so that the cash assets of the purchaser may be increased. Further, the distribution order of the purchaser may be upgraded according to the amount of cyber money distributed to him or her. Therefore, the possibility to get a larger amount of dividend from another event is increased.

If the payment of the purchaser is made through the use of an interest-free installment program provided by a credit card company, the profit of the purchaser will be maximized. If the purchaser buys 483.00 dollar clothing in the conventional purchase system, he or she must prepare 483.00 dollars, which makes him or her feel burdened so that he or she is refrained from purchasing the clothing. Through the product sales promotion system 100 of the disclosed technology, the sales price is paid in interest-free installments, and next, the installment amount may be paid with the dividend distributed to the purchaser, thereby lessening the burden of the purchaser. Such an advantage is obtained because the value of time is turned into the cyber money. Particularly, if the dividend distribution rate is raised by the seller, the amounts to be distributed to the purchasers are increased, so that the consumption will and event join will of the members become high.

Under the product sales promotion system according to the embodiments of the disclosed technology, the seller accomplishes a substantially larger amount of sales than an amount of sales in the past, for a short period of time, thereby obtaining a great sales profit, and even if the dividend is distributed, an amount of sales over several months to years can be obtained within the short period of time, so that no damage occurs. Also, the dividend, as a sales agency commission, is the amount paid to the system provider of the conventional system, and therefore, the seller does not have any substantial damage even if seller distributes the dividend. So as to increase the amount of sales in a short period of time, the dividend distribution rate may be selectively raised by the seller, which strongly stimulates the event join desires of the members to rapidly and reliably achieve a desired amount of product sales.

The product sales promotion system of an embodiment of the disclosed technology may obtain profits with the system usage fee received from the seller when the event is activated by the seller and with the withdrawal fees received from the members when the cyber money is withdrawn from the cyber money accounts by the members. Further, if the number of events activated by numerous sellers over the world is uncountably large, the cash balance in the system account unit 150, which is obtained by the events, is kept to a very large amount of money. Therefore, a cyber money mortgage or secondary outsourcing investment may be conducted by means of the system usage fees, the withdrawal fees, and the cash balance in the system account, thereby creating great profits.

The members may withdraw the cyber money from their cyber money accounts and exchange the cyber money into the cash, or they may get a loan with their cyber money as collateral from the product sales promotion system. The members may exchange their cyber money into the cash with a payment of the withdrawal fees, but in this case, the amount of cyber money retained in the cyber money account is decreased and this may cause a disadvantage in ranking of the dividend distribution order of an event. So as to allow the member to exchange the cyber money into the cash in the state where the amount of cyber money retained is kept, the product sales promotion system may lend the cash of the system account unit to the members with the cyber money of the members as collateral. As a result, the product sales promotion system may provide a financial business.

It may be appreciated that the product sales promotion system according to the embodiments of the disclosed technology provides a consuming-tech (consumption+financial technology) system that increases wealth through consumption, and as increased consumption may increase wealth, so that consumption, commercial exchange, and turnover rate are optimized to achieve significant advance in E-commerce unlike the conventional one.

While the disclosed technology has been described with reference to the particular illustrative embodiments, it is not to be restricted by the embodiments but only by the appended claims. It is to be appreciated that those skilled in the art can change or modify the embodiments without departing from the scope and spirit of the disclosed technology.

### EXPLANATION ON REFERENCE NUMERALS

10: seller terminal
20: purchaser terminal
100: product sales promotion system
110: event configuration unit
120: event management unit
130: product payment unit
140: member account unit
150: order calculation unit
160: dividend distribution unit
170: system account unit delivery management unit
180: delivery management unit
190: purchase confirmation management unit

What is claimed is:

1. A product sales promotion system for selling products on online, comprising:
a member account unit assigned to a member who joins in the product sales promotion system;
an order calculation unit adapted to determine a distribution order in an order of an amount deposited in the member account unit; and
a dividend distribution unit adapted to distribute a priority member dividend which is a part of a dividend calculated from a payment for a product to at least one priority member who ranks ahead a purchaser in the distribution order.

2. A product sales promotion system for selling products on online, comprising:
a member account unit assigned to a member who joins in the product sales promotion system;
an order calculation unit adapted to determine distribution order in an order of an amount deposited in the member account units; and
a dividend distribution unit adapted to distribute a priority member dividend which is a part of a dividend calculated from a payment of a product to a priority member who ranks ahead a purchaser in the distribution order and the purchaser.

3. The product sales promotion system according to claim 1, wherein the dividend distribution unit distributes a purchaser dividend which is another part of the dividend to the purchaser.

4. The product sales promotion system according to claim 3, wherein the sum of the priority member dividend and the purchaser dividend is the same as the dividend.

5. The product sales promotion system according to claim 3, wherein after the dividend distribution unit distributes the purchaser dividend to the purchaser, the order calculation unit determines the distribution order.

6. The product sales promotion system according to claim 2, wherein the dividend distribution unit distributes a purchaser dividend which is another part of the dividend to the purchaser.

7. The product sales promotion system according to claim 6, wherein the sum of the priority member dividend and the purchaser dividend is the same as the dividend.

8. The product sales promotion system according to claim 6, wherein after the dividend distribution unit distributes the purchaser dividend to the purchaser, the order calculation unit determines the distribution order.

9. A product sales promotion method for selling products through a product sales promotion system, the method comprising:
determining first distribution order in an order of the amount deposited in a member account unit assigned to a member who joins in the product sales promotion system by an order calculation unit;
performing a payment for a product by a product payment unit; and
distributing a priority member dividend which is a part of a dividend calculated from the payment for the product to at least one priority member who ranks ahead a purchaser in the distribution order by a dividend distribution unit.

10. The product sales promotion method according to claim 9, wherein in the distributing the priority member dividend, the priority member dividend is distributed to every priority members who ranks ahead the purchaser in the distribution order and further distributed to the purchaser by the dividend distribution unit.

11. The product sales promotion method according to claim 9, further comprising distributing a purchaser dividend which is another part of the dividend to the purchaser by the dividend distribution unit.

12. The product sales promotion method according to claim 11, wherein the sum of the priority member dividend and the purchaser dividend is the same as the dividend.

13. The product sales promotion method according to claim 11, wherein after the dividend distribution unit distributes the purchaser dividend to the purchaser, the order calculation unit updates the distribution order, and the priority member dividend is distributed according to the updated distribution order.

14. The product sales promotion method according to claim 10, further comprising distributing a purchaser dividend which is another part of the dividend to the purchaser by the dividend distribution unit.

15. The product sales promotion method according to claim 14, wherein the sum of the priority member dividend and the purchaser dividend is the same as the dividend.

16. The product sales promotion method according to claim 14, wherein after the dividend distribution unit distributes the purchaser dividend to the purchaser, the order calculation unit updates the distribution order, and the priority member dividend is distributed according to the updated distribution order.
